(19) United States
(12) Patent Application Publication
(10) Pub. No.: US 2003/0119578 A1
(43) Pub. Date: Jun. 26, 2003

(54) Gaming machine

(76) Inventor: John Edward Newson, Kingsford (AU)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/316,769

(22) Filed: Dec. 11, 2002

(30) Foreign Application Priority Data
Dec. 11, 2001 (AU) PR9435

(51) Int. Cl. A63F 13/00

(52) U.S. Cl. 463/20

(57) ABSTRACT

The present invention is directed to a gaming machine and a method of operation such a gaming machine. The gaming machine comprises: a video screen adapted to display a game of chance involving game events having random outcomes including winning outcomes and losing outcomes; and means adapted to display a range of video clips, each video clip being designated as either a winning video clip or a losing video clip; wherein the machine displays one of the winning video clips in response to one of the winning outcomes of a game event, and displays one of the losing video clips in response to one of the losing outcome of a game event.

### BACKGROUND OF THE INVENTION

The present invention relates to gaming machines and in particular computerized gaming machines. However, it will be appreciated that the invention is not limited to that particular field of use and may be suitable for many applications such as gaming facilitated by the Internet.

Gaming machines are widely known and are now one of the most common forms of gambling. One of the oldest and best known gaming machines is the rotating reel type “poker machine”. Poker machines use a series of 3, 4 or 5 reels each having symbols on its peripheral edge. Reels are rotated upon the placement of a bet then stopped to produce an array of randomly arranged symbols. Winnings are paid if the random arrangement symbols matches one of the predetermined winning combinations.

Computerized gaming machines use a video screen display instead of physically rotating reels. The display typically presents an array of symbols in five columns and three rows corresponding to the symbols that would normally be seen on the five physically rotating reels of an old style mechanical machine. Computerized machines have allowed players to simultaneously bet on the combination of symbols appearing in many different parts of the array. These parts of the array are often referred to as “paylines” consisting of lines of adjacent symbols extending through the array. The symbols may be laterally adjacent to each (as in from the same row) or diagonally adjacent to each other. They usually extend a long each row as well as various angled or zig zag lines through the array. The ability to bet on many different paylines simultaneously makes the game more interesting and exciting for players.

In an on-going effort to enhance the gaming experience most poker machines will now incorporate a secondary game known as a “feature”. Game designers use features to award players with large winnings and so features become an important factor in a player's choice of gaming machine. The feature is often the players only point of distinction between different gaming machines and therefore game designers strive to broaden the appeal of features as much as possible. Likewise there is also ongoing pressure to devise new features, or fresh adaptations of old features, in order to maintain player interest.

### SUMMARY OF THE INVENTION

In accordance with the present invention, there is provided a gaming machine which overcomes or ameliorates at least one of the disadvantages of the earlier gaming machines, or provides a useful alternative.

Further, in accordance with the present invention, there is provided a gaming machine comprising:

a video screen adapted to display a game of chance involving game events having random outcomes including winning outcomes and losing outcomes;

means adapted to display a range of video clips, each video clip being designated as either a winning video clip or a losing video clip,

wherein the machine displays one of the winning video clips in response to one of the winning outcomes of a game event, and displays one of the losing video clips in response to one of the losing outcomes of a game event.

Still further, in accordance with the present invention, there is provided a method of operating a gaming machine having a video screen and being adapted to display a range of video clips, the method including the steps of:

displaying a game of chance on the video screen, the game of chance involving game events having random outcomes including winning outcomes and losing outcomes;

designating some of the video clips to be winning video clips and designating some of the video clips to be losing video clips;

displaying one of the winning video clips in response to one of the wining outcomes of the game event; and

displaying one of the losing video clips in response to one of the losing outcomes of the game event.

The video clips provide visual reinforcement for the events of the game. Video clips showing a brief sequence having a positive and successful nature will emphasize a winning outcome and likewise, clips with a negative and unsuccessful nature emphasize losing outcomes. This increases the level of engagement with the game and maintains player interest for longer periods.

Preferably, the winning and losing video clips displayed in response to the outcomes of the game events are randomly selected. By randomly selecting the video clips from a range of different clips, there is less likelihood that the player will become familiar and bored whenever the clips occur.

In some embodiments, the range of video clips is stored remotely from the gaining machine; wherein the gaming machine is adapted to import the video clips when required. In other embodiments, the range of video clips is stored by the gaming machine for access when required.

Preferably, the video clips are linked by a common theme. In a further preferred form, the theme is related to the location and nature of the venue in which the gaming machine is located.

In one particularly preferred form, the common theme is a sport and the winning video clips show participants of the sport successfully executing maneuvers associated with the sport. Conversely, the losing video clips show participants unsuccessfully executing maneuvers associated with the sport.

Conveniently, the game event is a feature wherein upon the occurrence of a trigger, the gaming machine randomly determines whether the outcome of the feature is a winning outcome or a losing outcome, and it then displays one of the winning video clips or one of losing video clips accordingly such that the player is not aware of the outcome of the feature until the conclusion of the video clip. This focuses the player's attention on the video clip, by keeping the player in suspense as to whether the feature has a winning or a losing outcome until the clip ends.

If the gaming machine is located in a football club, it can be assumed that most players would be members of the club and have at least a passing interest in football and some knowledge of how the sport is played. In light of this, it would be convenient for the winning clips to depict maneuvers in which a player, or a team, successfully score a try, touchdown or goal (depending on the football code). Losing video clips would depict maneuvers that failed to score or show the opposing team scoring. In this way, the game designer is assured there is a high probability that the feature will hold some appeal to players at a particular venue as it derives its theme from the venue itself. Furthermore, the characters shown in the video clips can be prominent players in the team thereby drawing on their personal appeal and celebrity to enhance the feature.

In another example, the common theme may be a surf carnival for machines installed in surf life saving clubs. The winning video clips can show a surfer riding a wave through to the beach whereas the losing video clips can show the surfer being dumped by the wave.

The use of such randomly selected video clips is particularly suitable as a “mini feature” of a gaming machine designed to trigger relatively frequently. For instance, the mini feature trigger may be a “scatter” of two designated symbols appearing anywhere in the reels of the base game. This would occur fairly often and allow the feature to award the player with relatively modest prizes, such as, a set number of credits, or double, or triple the winnings in the base game.

By triggering often, the video clip provides a fairly constant point of interest for the player. Not every clip will be a winning clip and the prizes may be modest, but the subject of the clip itself maintain the game's appeal to the player.

These and other advantages and aspects of the present invention will be appreciated by one skilled in the art upon reading and understanding the specification.

### BRIEF DESCRIPTION OF THE DRAWINGS

Preferred embodiments of the invention will now be described, by way of example only, with reference to the accompanying drawings in which:

FIG. 1 is a perspective view of a stand-alone gaming machine of the type suitable for the present invention; and

FIG. 2 is a schematic representation of the gaming machine display having triggered the feature mode of operation.

### DETAILED DESCRIPTION OF THE PREFERRED EMBODIMENTS

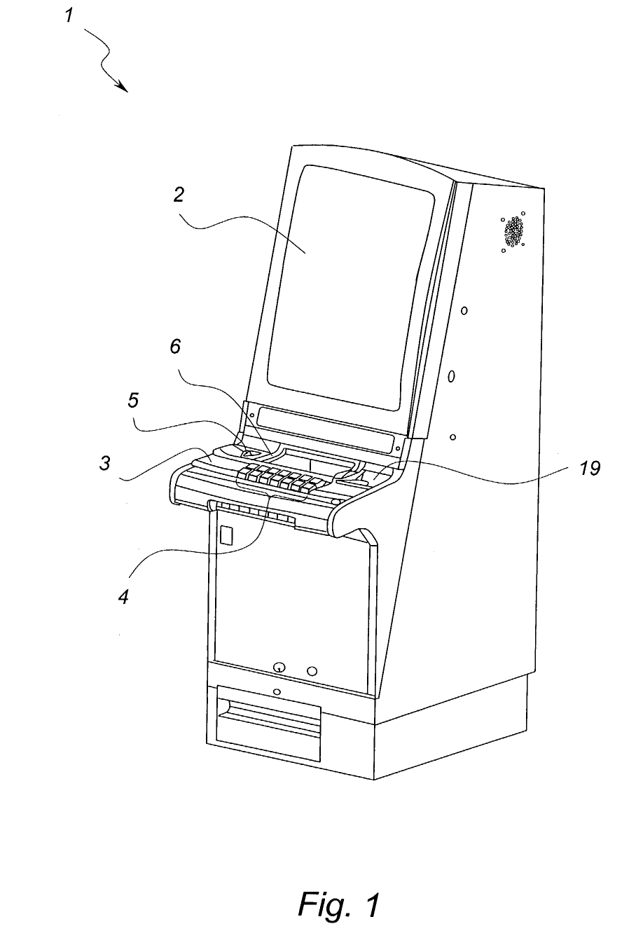

Referring to FIG. 1, the gaming machine 1 has a video display screen 2 and control console 3. The control console 3 includes coin slot 5 for inserting coins or tokens, a banknote slot 19, and a coin collection tray 6 for redeeming any winnings or unused coins or tokens. The console 3 also includes control buttons 4 for the player to select the number of paylines on which to bet, and the number of credits they wish to bet on each payline.

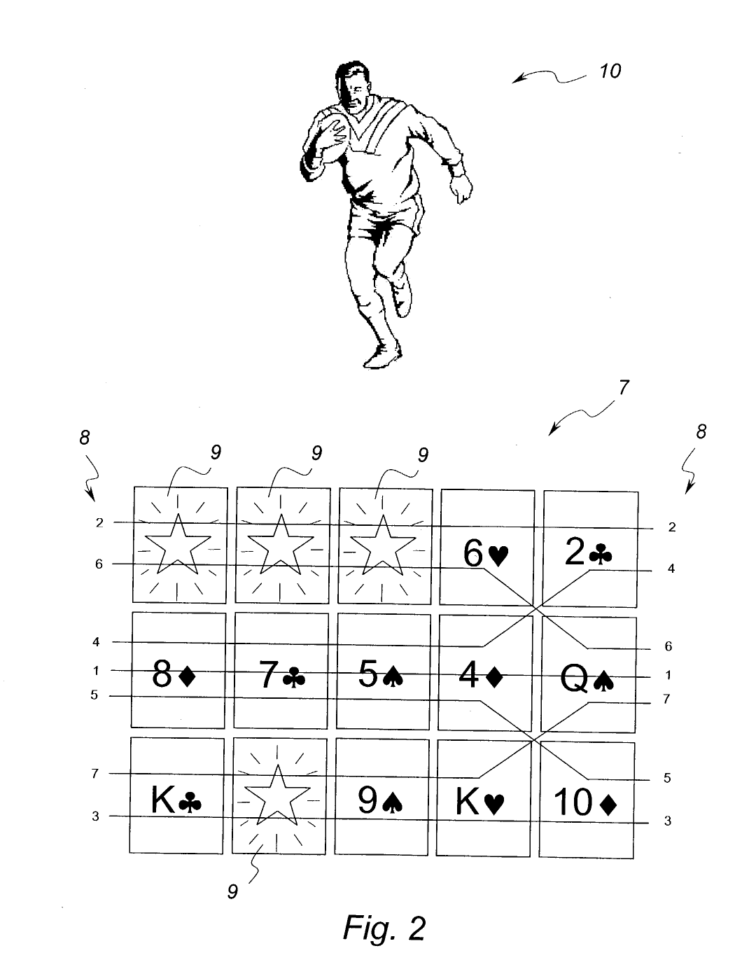

FIG. 2 shows a schematic representation of the display presented on the screen 2 when the feature is triggered. The base game is a standard set of five reels, which present a five-column, three-row array 7 of randomly selected symbols. The array 7 has seven paylines, 1-1 to 7-7 on which the player can place a bet. The payline icons 8 are placed on either side of the array 7 to more clearly indicate the configuration of each payline. Any paylines carrying a bet and showing one of the predetermined winning combinations of symbols is a winning payline and credits are added to the credit meter (not shown).

One or more of the random outcomes in the array 7 would be a designated trigger for initiating the feature game. In the present case, four of the wildcard symbols 9 anywhere in the array (known as a “scatter”) will trigger the machine to initiate the feature. The gaming machine randomly determines whether or not the feature has a winning or losing outcome and selects a video clip accordingly. The clips are designated winning video clips or losing video clips and randomly selected from the designated category once the machine has determined whether or not the feature will win or lose.

The machine shown is installed at a venue associated one of the rugby codes of football. Therefore, all the video clips 10 depict brief sequences of play from a football game. As the patrons of the club are likely to have some interest in the football and at least some knowledge of its rules, they will be able to readily recognize whether the video clip shown is a winning video clip or a losing video clip. Successfully completing certain football maneuvers or scoring a try would clearly designate a winning video clip whereas showing a clip where the player is tackled or the opposing team scores a try is clearly a losing video clip.

If the venue is the clubhouse of a local football team, the video clips 10 can depict figures in the local team's uniform or even depict individual players from the team. This will serve to enhance the level of engagement that the player has with the gaming machine based on a pre-existing interest in the sport and team associated with the clubhouse.

The typical duration of each clip and the prevalence of computerized gaming machines make the invention well suited to the use of “streaming” technology. Streaming is a technique for transferring data such that it can processed as a steady and continuous stream. If the video clips are stored as a digital file, they will necessarily require a significant amount of memory. Transferring the data to the electronics controlling the operation of the display screen may involve a short delay that detracts from the continuity of the gaming experience. However, with streaming, the video card can start displaying the video clip before the entire data file has been transmitted.

This technology also allows the video clips to be stored remote from the screen. For example, a central server can be linked to a bank of screens within the venue or at different venues. This allows the gaming machine manufacturer to frequently refresh and update the video clips available, possibly even incorporating clips from the team's last game. This enhances player interest by forging a connection with their sporting team's current performance.

The use of streamed video clips would be well-suited to mini- features, which would trigger relatively frequently and thereby provide a fairly constant incentive to the player. For example, triggering the feature in response to a scatter of any two symbols in the array 7 would mean the occurrence of the feature is relatively high. As a result, the prize awarded by a winning outcome of the feature would need to be relatively low. For example, a modest number of additional credits or perhaps doubling or tripling any credits won during the particular operation of the base game that triggered the feature.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A gaming machine comprising:
video screen display means adapted to display a game of chance involving game events having random outcomes including winning outcomes and losing outcomes;
means adapted to display a range of video clips, each video clip being designated as either a winning video clip or a losing video clip,
wherein the machine displays one of the winning video clips in response to one of the winning outcomes of a game event, and displays one of the losing video clips in response to one of the losing outcomes of a game event.

2. A gaming machine according to claim 1 wherein the winning and losing video clips are displayed in response to the outcomes of the game events are randomly selected.

3. A gaming machine according to claim 2 wherein the video clips are linked by a common theme.

4. A gaming machine according to claim 3 wherein the theme is related to the location and nature of the venue in which the gaming machine is located.

5. A gaining machine according to claim 4 wherein the common theme is a sport and the winning video clips show participants of the sport successfully executing maneuvers associated with the sport.

6. A gaming machine according to claim 5 wherein the losing video clips show participants unsuccessfully executing maneuvers associated with the sport.

7. A gaming machine according to claim 6 wherein the game event is a feature wherein upon the occurrence of a trigger, the gaming machine randomly determines whether the outcome of the feature is a winning outcome or a losing outcome, and the gaming machine then displays one of the winning video clips or one of losing video clips accordingly such that the player is not aware of the outcome of the feature until the conclusion of the video clip.

8. A gaming machine according to claim 1 wherein the range of video clips is stored remotely from the gaming machine; wherein the gaming machine includes means adapted to import the video clips when required.

9. A gaming machine according to claim 1 wherein the range of video clips is stored by the gaming machine for access when required.

10. A method of operating a gaming machine having a video screen and being adapted to display a range of video clips, the method comprising the steps of:
displaying a game of chance on the video screen, the game of chance involving game events having random outcomes including winning outcomes and losing outcomes;
designating some of the video clips to be winning video clips and designating some of the video clips to be losing video clips;
displaying one of the winning video clips in response to one of the wining outcomes of the game event; and
displaying one of the losing video clips in response to one of the losing outcomes of the game event.

11. A method of operating a gaming machine according to claim 10, wherein the winning and losing clips are displayed response to the outcomes of the game events are randomly selected.

12. A method of operating a gaming machine according to claim 11, wherein the video clips are linked by a common theme.

13. A method of operating a gaming machine according to claim 12, wherein the theme is related to the location and nature of the venue in which the gaming machine is located.

14. A method of operating a gaming machine according to claim 13, wherein the common theme is a sport and the winning video clips show participants of the sport successfully executing maneuvers associated with the sport.

15. A method of operating a gaming machine according to claim 14, wherein the losing video clips show participants unsuccessfully executing maneuvers associated with the sport.

16. A method of operating a gaming machine according to claim 15, wherein the game event is a feature, wherein upon the occurrence of a trigger, the gaming machine randomly determines whether the outcome of the feature is a winning outcome or a losing outcome, and the gaming machine then displays one of the winning video clips or one of losing video clips accordingly such that the player is not aware of the outcome of the feature until the conclusion of the video clip.

17. A method of operating a gaming machine according to claim 10, wherein the range of video clips are stored remotely from the gaming machine; wherein the gaming machine includes means adapted to import the video clips when required.

18. A method of operating a gaming machine according to claim 10, wherein the range of video clips are stored by the gaming machine for access when required.
